(19) United States
(12) Patent Application Publication
(10) Pub. No.: US 2020/0074997 A1
(43) Pub. Date: Mar. 5, 2020

(54) METHOD AND SYSTEM FOR DETECTING VOICE ACTIVITY IN NOISY CONDITIONS

(71) Applicant: CloudMinds Technology, Inc., Santa Clara, CA (US)

(72) Inventors: Charles Robert JANKOWSKI, JR., Fremont, CA (US); Charles COSTELLO, Santa Clara, CA (US)

(73) Assignee: CloudMinds Technology, Inc., Santa Clara, CA (US)

(21) Appl. No.: 16/543,603

(22) Filed: Aug. 18, 2019

Related U.S. Application Data
(60) Provisional application No. 62/726,191, filed on Aug. 31, 2018.

(51) Int. Cl. G10L 15/20; G10L 15/16; G10L 15/06; G10L 15/22; G10L 21/0216

(52) U.S. Cl. CPC G10L 15/20; G10L 15/16; G10L 2015/0633; G10L 15/22; G10L 21/0216; G10L 15/063

(57) ABSTRACT

A voice activity detection method includes: training one or more computerized neural networks having a denoising autoencoder and a classifier, wherein the training is performed utilizing one or more models including Mel-frequency cepstral coefficients (MFCC) features, Δ features, ΔΔ features, and Pitch features, each model being recorded at one or more differing associated predetermined signal to noise ratios; recording a raw audio waveform and transmitting the raw audio waveform to the computerized neural network; denoising the raw audio wave utilizing the denoising autoencoder; and determining whether the raw audio waveform contains human speech; extracting any human speech from the raw audio waveform.

### CROSS-REFERENCE TO RELATED APPLICATION

The present application claims priority to U.S. Provisional Patent Application No. 62/726,191 filed on Aug. 31, 2018, the disclosure of which is hereby incorporated by reference in its entirety.

### TECHNICAL FIELD

The present disclosure relates to voice recognition systems and methods for extracting speech and filtering speech from other audio waveforms.

### BACKGROUND

Voice Activity Detection (VAD) is a software technique used to determine whether audio contains speech or not, and to determine the exact position of speech within an audio wave form. VAD is often used as a first step in a speech processing system. It determines when a speaker is talking to the system, and consequently which segments of audio the system should analyze. Current VAD systems generally fall into one of two categories: deterministic algorithms based on measuring the energy of the audio waveform, and simple trained machine learning classifiers.

### SUMMARY

In a first aspect, a voice activity detection method is provided, including:

training one or more computerized neural networks having a denoising autoencoder and a classifier,

wherein the training is performed utilizing one or more models including Mel-frequency cepstral coefficients (MFCC) features, Δ features, AA features, and Pitch features, each model being recorded at one or more differing associated predetermined signal to noise ratios;

recording a raw audio waveform and transmitting the raw audio waveform to the computerized neural network; denoising the raw audio wave utilizing the denoising autoencoder;

determining whether the raw audio waveform contains human speech; and

extracting any human speech from the raw audio waveform.

In some embodiments, the computerized neural network can be provided as a convolutional neural network, a deep neural network, or a recurrent neural network.

In some embodiments, the classifier can be trained utilizing one or more linguistic models, wherein at least one linguistic model can be VoxForge™, or wherein at least one linguistic model is AIShell, or the classifier can be trained on both such models as well as utilizing additional alternative linguistic models.

In some embodiments, the system can be trained such that each linguistic model is recorded having a base truth for each recording, wherein each linguistic model is recorded at one or more of a plurality of pre-set signal to noise ratios with an associated base truth. In some such embodiments the plurality of pre-set signal to noise ratios range between 0 dB and 35 dB.

In some embodiments, the raw audio waveform can be recorded on a local computational device, and wherein method further comprises a step of transmitting the raw audio waveform to a remote server, wherein the remote server contains the computational neural network.

Alternatively, the raw audio waveform can be recorded on a local computational device, and wherein the local computational device contains the computational neural network. In some such embodiments, the computational neural network, when provided on a local device, can be compressed.

In another aspect, a voice activity detection system is provided, wherein the system can include:

a local computational system, the local computational system further including:

processing circuitry;

a microphone operatively connected to the processing circuitry;

a non-transitory computer-readable media being operatively connected to the processing circuitry;

a remote server configured to receive recorded wavelengths from the local computational system;

the remote server having one or more computerized neural networks, a denoising autoencoder module, and a classifier module,

wherein the computerized neural networks of the remote server are trained on a plurality of acoustic models,

wherein each of the plurality of acoustic models represent a particular linguistic dataset recorded in one or more associated noise predetermined signal to noise ratios;

wherein the non-transitory computer-readable media contains instructions for the processing circuitry to perform the following tasks: utilize the microphone to record raw audio waveforms from an ambient atmosphere; transmit the recorded raw audio waveforms to the remote server; and

wherein the remote server contains processing circuitry configured to utilize the denoising autoencoder module to perform a denoising operation on the recorded waveform and utilize the classifier to classify the recorded wavelengths as speech or non-speech, extract the speech from the recorded raw audio waveforms, perform a speech-to-text operation, and transmit one or more extracted strings of speech characters back to the local computational system.

In another aspect, a voice activity detection system is provided, wherein the system can alternatively include:

a local computational system, the local computational system further comprising: processing circuitry;

a microphone operatively connected to the processing circuitry; a non-transitory computer-readable media being operatively connected to the processing circuitry;

one or more computerized neural networks including: a denoising autoencoder module, and

a classifier module, wherein the computerized neural networks of the remote server are trained on a plurality of acoustic models, wherein each of the plurality of acoustic models represent a particular linguistic dataset recorded in one or more associated noise predetermined signal to noise ratios;

wherein the non-transitory computer-readable media contains instructions for the processing circuitry to perform the following tasks: utilize the microphone to record raw audio waveforms from an ambient atmosphere; transmit the recorded raw audio waveforms to the one or more computerized neural networks; and

wherein at least one computerized neural network is configured to utilize the denoising autoencoder module to perform a denoising operation on the recorded waveform and utilize the classifier to classify the recorded wavelengths as speech or non-speech, extract the speech from the recorded raw audio waveforms, perform a speech-to-text operation, and transmit one or more extracted strings of speech characters back to the local computational system.

In another aspect, a vehicle comprising a voice activity detection system is provided, the system including:

a local computational system, the local computational system further including:

processing circuitry;

a microphone operatively connected to the processing circuitry;

a non-transitory computer-readable media being operatively connected to the processing circuitry;

one or more computerized neural networks including:

a denoising autoencoder module, and

a classifier module, wherein the computerized neural networks are trained on a plurality of acoustic models, wherein each of the plurality of acoustic models represent a particular linguistic dataset recorded in one or more associated noise predetermined signal to noise ratios;

wherein the non-transitory computer-readable media contains instructions for the processing circuitry to perform the following tasks:

utilize the microphone to record raw audio waveforms from an ambient atmosphere;

transmit the recorded raw audio waveforms to the one or more computerized neural networks; and

wherein at least one computerized neural network is configured to utilize the denoising autoencoder module to perform a denoising operation on the recorded waveform and utilize the classifier to classify the recorded wavelengths as speech or non-speech, extract the speech from the recorded raw audio waveforms, perform a speech-to-text operation, and transmit one or more extracted strings of speech characters back to the local computational system.

In some embodiments, the classifier is trained utilizing a plurality of linguistic models, wherein at least one linguistic model is VoxForge™ and at least one linguistic model is AIShell; and the computational neural network is compressed.

In some embodiments, the vehicle is one of an automobile, a boat, or an aircraft.

It should be understood that both the foregoing general description and the following detailed description are exemplary and explanatory only and are not restrictive of the disclosure. Other aspects and embodiments of the present disclosure will become clear to those of ordinary skill in the art in view of the following description and the attached drawings.

### BRIEF DESCRIPTION OF THE DRAWINGS

To more clearly illustrate some of the embodiments, the following is a brief description of the drawings.

The drawings in the following descriptions are only illustrative of some embodiments. For those of ordinary skill in the art, other drawings of other embodiments can become apparent based on these drawings.

FIG. 1 illustrates an exemplary schematic view of a system which can be configured to implement various methodologies and steps in accordance with various aspects of the present disclosure;

FIG. 2 illustrates an exemplary schematic view of an alternative potential system which can be configured to implement various methodologies and steps in accordance with various aspects of the present disclosure;

FIG. 3 illustrates an exemplary flow chart showing various exemplary framework and associated method steps which can be implemented by the system of FIGS. 1-2;

FIG. 4 illustrates an exemplary flow chart showing various exemplary framework and associated method steps which can be implemented by the system of FIGS. 1-2;

FIG. 5 illustrates an exemplary flow chart showing various exemplary framework and associated method steps which can be implemented by the system of FIGS. 1-2;

FIG. 6 illustrates an exemplary graph showing a plot of a long-term spectrum of the Mobile World Congress (MWC) noise at an 8 kHz sampling rate; and

FIG. 7 is a schematic diagram illustrating an apparatus with microphones for receiving and processing sound waves.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. can be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or other structure is referred to as being “on” or extending “onto” another element, it can be directly on or extend directly onto the other element or intervening elements can also be present. In contrast, when an element is referred to as being “directly on” or extending “directly onto” another element, there are no intervening elements present.

Likewise, it will be understood that when an element such as a layer, region, or substrate is referred to as being “over” or extending “over” another element, it can be directly over or extend directly over the other element or intervening elements can also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present.

Relative terms such as “below” or “above” or “upper” or “lower” or “vertical” or “horizontal” can be used herein to describe a relationship of one element, layer, or region to another element, layer, or region as illustrated in the drawings. It will be understood that these terms and those discussed above are intended to encompass different orientations of the device in addition to the orientation depicted in the drawings.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The inventors of the present disclosure have recognized that, VAD systems typically are only trained on a single type of linguistic models with the models being recorded only in low noise environments. A major challenge in developing VAD systems is distinguishing between audio from the speaker and background noises. Often, conventional approaches will mistake background noise for speech. As such, these models only provide acceptable speech recognition in low-noise situations and degrade drastically as the noise level increases.

Further, conventional systems typically only extract a single type of Mel-frequency cepstral coefficients (MFCC) features from the recorded raw audio waveforms resulting in the voice recognition which is unable to adapt to numerous types or background noises. In the real-world users who may rely on VAD interfaces often encounter wide ranging noise levels and noise types which often render previous VAD systems unsuitable.

Various embodiments of the present disclosure provide improvements over existing VAD systems by utilizing a series of techniques that add robustness to voice activity detection in noisy conditions, for example, through rich feature extraction, denoising, recurrent classification, etc. Different machine learning models at different noise levels can be employed to help optimize the VAD approaches suitable in high noise environments.

Briefly, feature extraction refers to a process which transforms the raw audio waveform into a rich representation of the data, allowing for discrimination between noise and speech. Denoising refers to a process which removes noise from the audio representation thus allowing the classifier to better discriminate between speech and non-speech. Finally, a recurrent classifier takes temporal information into account, allowing the model to accurately predict speech or non-speech at different timesteps.

These techniques provide the contemplated system with much greater robustness to noise than a mere energy level and simple machine learning based approaches. This in turn gives the contemplated system much greater effectiveness than it would otherwise have.

It has been recognized that, both deterministic algorithms and simple trained machine learning classifiers generally do poorly in noisy conditions. This poor performance is due to the fact that merely using waveform energy does not allow the system to differentiate between noise and speech, as both may have high energy, which potential similarity leads to vastly degraded performance in noisy conditions. Traditional machine learning approaches generally perform better than energy-based approaches due to their ability to generalize, but still often degrade rapidly in noisy conditions, as they are trained on noisy representation of the audio.

In order to overcome these and many other deficiencies and provide robust performance in noisy conditions, contemplated herein is a sophisticated machine learning pipeline that will alleviate these problems by taking a raw audio waveform and analyzing the raw audio waveform by utilizing a series of techniques that add robustness to noise. Such techniques can include the following: rich feature extraction, denoising, and a feeding the waveforms to a recurrent classifier which can then be utilized to ultimately classify a plurality of raw audio waveforms as speech or non-speech.

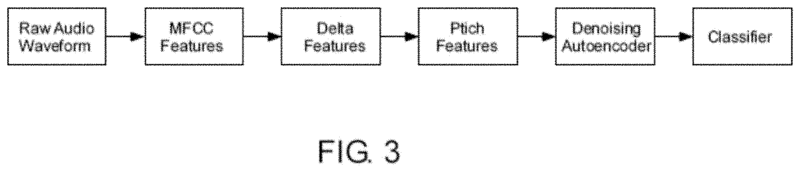

In order to achieve this, such as in an exemplary system contemplated herein, and as illustrated in FIG. 3, the system illustrated herein focuses on improving Voice Activity Detection (VAD) in noisy conditions by implementing a Convolutional Neural Network (CNN) based model, as well as a Denoising Autoencoder (DAE), and experiment against acoustic features and their delta features in various predetermined noise levels ranging from signal-to-noise ratio (SNR) of 35 dB to 0 dB.

The experiments compare and find the best model configuration for robust performance in noisy conditions. In the proposed system, the system is utilized for combining more expressive audio features with the use of DAEs so as to improve accuracy, especially as noise increases. At 0 dB, the proposed model trained with the best feature set could achieve a lab test accuracy of 93.2%, which was averaged across all noise levels, and 88.6% inference accuracy on a specified device.

The system can then be utilized to compress the neural network and deploy the inference model that is optimized for an application running on the device such that the average on-device CPU usage is reduced to 14% from 37% thus improving battery life of mobile devices.

Traditional VADs such as ETSI AMR VAD Option and G.729B have historically utilized parameters such as frame energies of different frequency bands, Signal to Noise Ratio (SNR) of a surrounding background, channel, and frame noise, differential zero crossing rate, and thresholds at different boundaries of the parameter space for deciding whether detected waveforms represent speech or mere background noise. The problems of these parameters are realized in situations having increased noise and lower SNRs.

In some alternative situations Deep Belief Network (DBN) can be implemented which can be utilized to extract the underlying features through nonlinear hidden layers and connects with a linear classifier can obtain better VAD accuracies than G.729B.

Contemplated herein is the use of acoustic features combined with SVM approaches which allow for some improvements in noisy conditions. Deep neural networks have been proved to capture temporal information, approaches which can then feed MFCC or Perceptual Linear Prediction (PLP) features to feed-forward deep neural networks (DNNs) and recurrent neural networks (RNNs). DNNs coupled with stacked denoising autoencoders,

The system of the present disclosure contemplates a systematical analysis of how different feature sets allow for more robust performance of VAD in noisy conditions by improving VAD performance by CNNs combining with DAEs, Mel Frequency Cepstral Coefficients (MFCC)s or filter banks, and their combinations in noisy conditions and by providing a comparison of two optimization frameworks for VAD model deployment on device towards lower CPU usage.

Contemplated herein is a VAD system which is robust in order to accommodate noisy conditions. To this end, the system utilizes the AISHELL1 (AISHELL) Chinese Mandarin speech corpus as s speck comparison database in conjunction with manually labeled beginnings and ends of voice frames.

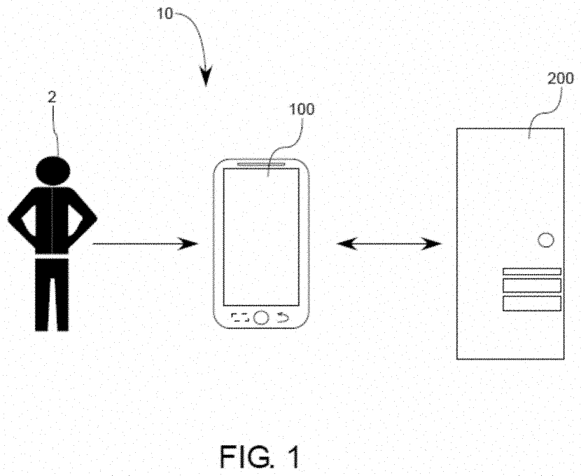

In order to implement these methods, contemplated herein is a system 10 which utilizes a known VAD system which receives raw audio waveform from a user 2, performs VAD classification on a local computational device, i.e. a smart device, and sends the result to a Cloud-based AI platform. This flow can be seen in FIG. 1 and described as follows: a user 2 speaks into the smart device 100, which device includes a microphone, processing circuitry, and non-transitory computer-readable media containing instructions for the processing circuitry to complete various tasks.

Using the smart device 100, audio can be recorded as a raw audio waveform; the VAD system 10 transforms the raw audio waveform and classifies as speech or non-speech; the speech audio waveform is then sent to a Cloud-based AI platform 200 for further speech processing, determines whether speech has been detected by denoising the raw audio waveform and a classifier then compares the denoised audio waveform to one of a plurality of trained models and determines whether speech has been detected thereby.

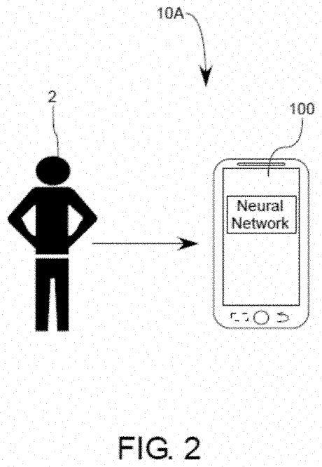

It will then be appreciated that the smart device as discussed here is only offered as an exemplary implementation wherein any computational device may be used. Further, while the Cloud-based AI platform can also as discussed here is only offered as an exemplary implementation wherein any machine learning as discussed herein may also be implemented locally such as in the implementation illustrated in FIG. 2 by system 10A, but this exemplary embodiment is only made for purposes of providing an exemplary framework in which to discuss the methods and steps forming a core of the inventive concepts discussed herein.

As contemplated herein, the VAD system 10 implements a series of steps which allows it to operate as a machine learning pipeline, with different components for feature extraction, denoising, and classification.

The flow can be seen in FIG. 2 and described as follows: audio is received as raw waveform from the smart device microphone; MFCC features are then extracted from raw audio waveform; delta features are then extracted from MFCC features and added to MFCC features; pitch features are then extracted from MFCC features and added to MFCC and delta features; a denoising autoencoder can then be used to remove background noise from features; and a recurrent classifier can then be used to determine if audio is speech or non-speech.

In the system contemplated herein Voice Activity Detection (VAD) is greatly improved under noisy conditions by implementing a two-deep machine learning process during a classification model formation, as well as a denoising autoencoder to run experiments.

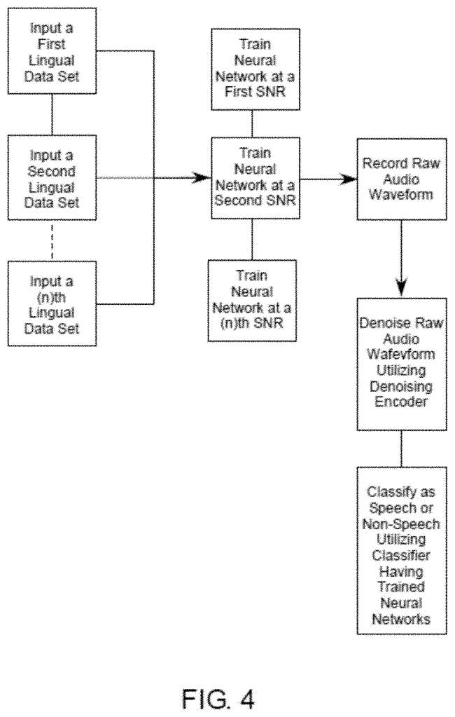

In the methods contemplated herein, and as shown in FIG. 4, two or more datasets can be utilized, such datasets can include a first data set, which can be provided as an English VoxForge™ data set, and a second data set, which can include a Mandarin AISHELL data set, each of which can be provided having a plurality of noise levels. For exemplary purposes, and for purposes of driving discussion, five different noise levels can be provided for each data set. Wherein VoxForge™ is an English dataset gathered specifically to provide an open source annotated speech corpus to facilitate development of acoustic models and wherein AISHELL™ is a Mandarin corpus collected by Beijing Shell Technology.

Multiple data sets provided at various noise levels allows for the data to then be fed to a machine learning module which can then train a denoising autoencoder to clean data at one or more inference times. It was then observed that that utilizing a plurality of data sets allows for significantly more expressive audio features, as well as using a denoising autoencoder, improve performance, especially as noise increases.

The various device components, blocks, circuits, or portions may have modular configurations, or are composed of discrete components, but nonetheless may be referred to as “modules” in general. In other words, the “modules” referred to herein may or may not be in modular forms.

By utilizing two datasets from distinct and separate languages the VAD system is enabled to be more robust to noisy conditions regardless of the speaker's language.

In the system contemplated herein, two different deep learning models were developed for VAD classification, a first deep learning model, referred to herein as a convolutional neural network (CNN) and a second-deep learning model, referred to herein as a recurrent neural network (RNN).

The system as contemplated herein also utilizes a denoising autoencoder (DAE) to remove background noise from audio. During the training process, the DAE is then utilized to convert the raw audio waveform into Mel-frequency cepstral coefficients (MFCC) features, which is then utilized as input into the models for training and denoising.

For some experiments, the system also extracts a plurality of A features and ΔΔ features wherein the system then links the Δ and ΔΔ features together in a chain or series with the MFCC features.

Table 1 illustrates various CNN architectures and associated data as determined by the system utilizing the datasets as discussed above.

TABLE 1
CNN Architectures

| Layer | Shape | Details |
|---|---|---|
| Input | (21, 13, 1) | n/a |
| Convolution | (21, 13, 64) | 3 × 3 |
| Pooling | (10, 6, 64) | 2 × 2 |
| Dropout | (10, 6, 64) | 0.5 |
| Flatten | (3840) | n/a |
| Dense 1 | (128) | n/a |
| Dropout | (128) | 0.5 |
| Dense 2 | (2) | n/a |

Table 2 illustrates various RNN architectures and associated data as determined by the system utilizing the datasets as discussed above.

TABLE 2
RNN Architectures

| Layer | Shape | Details |
|---|---|---|
| Input | (21, 13) | n/a |
| LSTM | (21, 13) | n/a |
| Dropout | (13) | 0.5 |
| Dense | (2) | n/a |

Table 3 illustrates various DAE architectures and associated data as determined by the system utilizing the datasets as discussed above.

TABLE 3
DAE Models Architectures

| Layer | Shape | Details |
|---|---|---|
| Input | (273) | n/a |
| Encoder 1 | (1024) | ReLu |
| Encoder 2 | (512) | ReLu |
| Encoder 3 | (256) | ReLu |
| Decoder 1 | (512) | ReLu |
| Decoder 2 | (1024) | ReLu |
| Decoder 3 | (273) | n/a |

Table 4 illustrates various experiments and results and associated data as determined by the system utilizing AISHELL RNN datasets as discussed above.

TABLE 4
Results Utilizing AISHELL RNN Datasets

| SNR | 5 | 10 | 15 | 20 | 35 |
|---|---|---|---|---|---|
| Neither | 74.31 | 84.19 | 95.59 | 97.73 | 98.52 |
| Deltas | 78.38 | 87.12 | 95.61 | 97.77 | 98.49 |
| Encoder | 71.59 | 84.77 | 96.88 | 97.88 | 98.48 |
| Both | 81.38 | 89.07 | 97.65 | 97.72 | 98.55 |

Table 5 illustrates various experiments and results and associated data as determined by the system utilizing AISHELL CNN datasets as discussed above.

TABLE 5
Results Utilizing AISHELL CNN Datasets

| SNR | 5 | 10 | 15 | 20 | 35 |
|---|---|---|---|---|---|
| Neither | 62.88 | 78.32 | 93.44 | 97.13 | 98.63 |
| Deltas | 70.80 | 85.51 | 95.42 | 97.80 | 98.62 |
| Encoder | 76.59 | 89.06 | 95.96 | 97.14 | 98.55 |
| Both | 81.85 | 91.99 | 97.16 | 97.43 | 98.63 |

Table 6 illustrates various experiments and results and associated data as determined by the system utilizing VoxForge™ RNN datasets as discussed above.

TABLE 6
Results Utilizing VoxForge ™ RNN Datasets

| SNR | 5 | 10 | 15 | 20 | 25 |
|---|---|---|---|---|---|
| Neither | 64.53 | 74.23 | 83.86 | 87.29 | 87.48 |
| Deltas | 61.27 | 73.71 | 84.41 | 85.74 | 87.21 |
| Encoder | 63.74 | 72.00 | 80.55 | 83.69 | 86.27 |
| Both | 67.03 | 72.84 | 81.58 | 83.04 | 85.05 |

Table 7 illustrates various experiments and results and associated data as determined by the system utilizing VoxForge™ CNN datasets as discussed above.

TABLE 7
Results Utilizing VoxForge ™ CNN Datasets

| SNR | 5 | 10 | 15 | 20 | 25 |
|---|---|---|---|---|---|
| Neither | 45.36 | 4.73 | 72.75 | 82.74 | 84.37 |
| Deltas | 38.19 | 0.00 | 61.76 | 80.30 | 89.50 |
| Encoder | 52.89 | 65.31 | 74.26 | 78.11 | 83.30 |
| Both | 68.32 | 74.43 | 82.39 | 84.17 | 88.31 |

Each of the above Tables 4-7 shows four different model configurations: “Neither,” which uses only MFCC features without the DAE; “Deltas,” which uses the Δ and ΔΔ features in addition to the MFCC features; “Encoder,” which uses the DAE but not the Δ or ΔΔ features; and “Both,” which uses the Δ and ΔΔ features as well as the DAE.

The system as contemplated herein can then be utilized to run each model configuration on five different noise conditions: roughly 5 10, 15, 20, and 25 or 35 SNR so as to train the neural network using a plurality of specifically trained models and thus provide an increased accuracy of detection in real-world environments.

In some embodiments, the 25 and 35 SNR cases or training models can be configured to correspond to clean VoxForge™ and AISHELL audio respectively, while the other SNRs have added noise. Each model can then be randomly initialized and trained for five time periods with a predetermined batch size, for example a batch size of 1024.

A few trends can be seen from analyzing these tables. The first is that, unsurprisingly, performance increases as noise decreases. More interestingly, we can see from the results that the Δ and ΔΔ features as well as denoising the input with a DAE generally increase model performance. Specifically, for the CNN model, using delta features tends to be very beneficial, but as noise increases, for each model and dataset, models with both delta features and DAE perform the best.

As such, the system as contemplated herein which utilizes a DAE to clean audio is beneficial, and that Δ and ΔΔ features which generally increase performance.

Consequently, use of both of these techniques greatly increases the effectiveness of the contemplated VAD system, particularly when utilized in noisy conditions.

In some embodiments, the SNR of the original data set can be provided as 35 dB which best represents real-world like noise environments. Additive background noises are then added to the raw waveforms in order to simulate a variety of SNRs ranging from 0 dB to 20 dB.

It will then be appreciated that AISHELL is 178 hours long, and covers 11 domains. The recording utilized for model training was done by 400 speakers from different accent areas in China. The recordings were then utilized to create 4 noisy data sets at SNR 0, 5, 10, and 20 dB. Each of these data sets were then separated each into train, development, and test sets.

A convolutional neural network (CNN) was then provided and developed for the VAD system as contemplated herein, and a front-end Denoising Autoencoder (DAE) was utilized to remove background noise from input speeches.

To further explain why this CNN as well as a DAE topology is selected, it should be emphasized that the method is in line with the ideas of using neural networks to extract robust features. The hidden layers of the bottleneck DAE allows for learning low-level representation of the corrupted input distribution.

The CNN follows closely with the DNNs for VAD, but its convolution and pooling operations are more adept at reducing input dimensions. In addition, the denoised input is fed for the training and inference of the CNN classifier. Therefore, the CNN with DAE would benefit from the ability of recovering corrupted signals and hence enhance any representation of particular features, thus providing robustness.

As contemplated herein, the system can employ a 2-layer bottleneck network for the DAE, and set the encoding layers hidden unit sizes to predetermined values, for example 500 and 256. The system can then use the ReLU activation function for the encoder, followed by batch normalization. In some embodiments, an activation function or normalization can be applied for the decoder, or in some instances the activation function or normalization can be omitted.

In some such embodiments the DAE can be trained layer-wise using standard back-propagation. The objective function can then be root mean squared error between clean data {xᵢ}ᵢ₌₁^{N} and decoded data {\tilde{x}ᵢ}ᵢ₌₁^{N}, as defined as below.

$$𝒥 ( θ , {θ}^{′} ) = {min}_{θ , {θ}^{′}} \frac{1}{N} {\sum }_{i = 1}^{N} ℒ ( θ , {θ}^{′} ; {x}^{( i )} , {\tilde{x}}^{( i )} )$$

where L(.) represents the loss, θ and θ′ denote the encoding weights and biases, and the decoding weights and biases respectively.

The training data can consist of a predetermined amount of noisy data and clean data, for example 32 hours. In some embodiments, the noisy data can be a combined data set of SNRs 0, 5, 10, and 20 dB. For the clean counterpart, the system can utilize the original data which is very clean and has a SNR of 35 dB.

The model can then be pre-trained with MFCC features and Filter-Bank features. In some embodiments, each frame of features is concatenated with its left and right frames, by a window of size 21.

The DAE architectures in some embodiments are summarized in the following Table 8, wherein FS denotes the feature size.

TABLE 8
DAE Architectures in Some Other Embodiments

| Layer | Shape | Details |
|---|---|---|
| Input | (21 × FS) | n/a |
| Encoder 1 | (500) | ReLU |
| BatchNormalization | (500) | n/a |
| Encoder 2 | (256) | ReLU |
| BatchNormalization | (500) | n/a |
| Decoder 1 | (500) | None |
| Decoder 2 | (21 × FS) | None |

In some embodiments a frame-level CNN can be utilized having frame-based input features, denoised by DAEs, and labels {uᵢ, yᵢ}ᵢ₌₁^{N}.

In such embodiments, as each input frame can windowed by its neighboring 10 left and right frames, forming a 21-frame windowed input, wherein a 2D convolutional kernel can be used to reduce input size. The system can then be utilized to apply (3, 3) convolutional filters, (2, 2) max pooling strided by (2, 2), dropout, flatten, reduce the flattened features to a fully connected output, and then compute the logits.

The network can then be trained in mini-batches using back-propagation, to minimize the sparse softmax cross entropy loss between label {yᵢ}ᵢ₌₁^{N}, and the argmax of the last layer logits, denoted by {y′ᵢ}ᵢ₌₁^{N}. The loss function is defined below.

$${ℋ}_{{y}^{′}} ( y ) = - {\sum }_{i = 1}^{N} {y}_{i}^{′} log ( {y}_{i} )$$

Table 9 shows the CNN model architecture of the system contemplated herein. In inference time, the system can be utilized to apply a post-processing mechanism to CNN outputs for more accurate estimations. In Table 9 FS denotes the feature size and BS denotes the training batch size.

TABLE 9
CNN Architectures in Some Other Embodiments

| Layer | Dimensions | Details |
|---|---|---|
| Input | (BS, 21, FS, 1) | n/a |
| Convolution | (BS, 19, FS − 2, 64) | 3 × 3 |
| Max_Pooling | (BS, 9, (FS − 2)/2, 64) | 2 × 2 |
| Dropout 1 | (BS, 9 × (FS − 2)/2 × 64) | 0.5 |
| Flatten | (BS, 9 × (FS − 2)/2 × 64) | n/a |
| Dense 1 | (BS, 128) | n/a |
| Dropout 2 | (BS, 128) | 0.5 |
| Dense 2 | (BS, 2) | n/a |

The system can then receive a plurality of labels denoting a plurality of speech or non-speech frames from the training data, wherein the labels regarding whether each frame represents speech or non-speech can have been previously verified either manually or automatically.

In some embodiments of the VAD system as contemplated herein, the system can be configured to process the training waveforms in a predetermined frame width or length, for example with a 25 ms wide window, and advance the waveform with a sliding window having another predetermined length, for example a sliding window of 10 ms. The system can then extract multi-dimensional MFCC features at predetermine frequency sampling rate, for example a 13-dimensional MFCC feature at 16 kHz sampling rate.

Likewise, the system can then convert the raw waveforms into multi-dimensional log mel-filterbank (filterbank) features, for example 40-dimensional log mel-filterbank features. The filterbank features can then be normalized to a zero mean and unit variance per utterance based.

In some embodiments, and as shown in FIG. 3 additional expressive features can also be utilized. In such embodiments, the system can use Δ and ΔΔ features together with their associated MFCC or filterbank features.

In some additional embodiments, the input features can be denoised using pre-trained DAE.

In some additional embodiments, similar operations can be performed for development data and test data.

Table 10 illustrates test results of CNN's trained with various feature sets on the AISHELL dataset.

TABLE 10
Test accuracy (%) of CNNs using MFCC features on AISHELL

| SNR (dB) | 35 | 20 | 10 | 5 | 0 |
|---|---|---|---|---|---|
| MFCC | 96.93 | 95.76 | 92.49 | 88.91 | 83.97 |
| MFCC + DAE | 97.00 | 95.67 | 92.89 | 90.50 | 86.03 |
| MFCC, Δ, ΔΔ | 97.16 | 95.79 | 93.04 | 90.33 | 84.73 |
| MFCC + Combined | 97.16 | 96.01 | 93.24 | 91.90 | 87.90 |

In Table 10, the first row draws baseline accuracy results of using 13 MFCCs only, and unsurprisingly, the accuracy drops as noise level of the speeches increases. The second and third row illustrate that either the use of DAE or 39 MFCCs Δ and ΔΔ features would help improve the results, especially in noisier conditions. The last row adopts a combined approach of using both DAE and Δ, ΔΔ, and the accuracy turns out to be better than all rows above.

Table 11 illustrates results of adding normalized filterbank features with the original filterbank features. In this table it can be clearly observed that utilization of normalized features works better then unnormalized features. Secondly, significant improvements can be provided by using deltas which can found in both normalized and unnormalized filterbank features, with normalized filterbank+Δ and ΔΔ being the best accuracy feature configuration, as seen in row 6.

TABLE 11
Test Accuracy (%) of CNNs Using
Filterbank Features on AISHELL

| SNR (dB) | 35 | 20 | 10 | 5 | 0 |
|---|---|---|---|---|---|
| FBank | 95.81 | 92.26 | 88.11 | 83.92 | 78.13 |
| Norm. FBank | 96.32 | 93.46 | 88.65 | 87.63 | 84.04 |
| FBank + DAE | 95.71 | 93.20 | 89.02 | 84.63 | 79.74 |
| Norm. FBank + DAE | 95.67 | 93.24 | 89.18 | 85.04 | 82.80 |
| FBank, Δ, ΔΔ | 96.43 | 92.81 | 88.92 | 86.63 | 73.77 |
| Norm. FBank, Δ, ΔΔ | 96.56 | 94.82 | 90.30 | 88.47 | 85.24 |
| FBank + Combined | 95.04 | 90.21 | 88.71 | 83.88 | 80.62 |
| Norm. FBank + Combined | 95.85 | 92.83 | 89.82 | 85.78 | 82.25 |

This table illustrates an unexpected result in that the DAE exhibits limited improvements on the normalized filterbank features, and the combined approach did not depict the most effective improvements.

An explanation is that in some instances the system kept the exact same DAE architecture for both MFCCs and filterbanks during training for fair comparisons, but for filterbank features, whose dimensionality is larger than MFCCs, a deeper autoencoder is actually preferable.

Above all, MFCCs generally outperform filterbanks on this VAD task despite of different feature schemes.

In some embodiments the system can be utilized to compare frame-based VAD test accuracies of a preferred model on Mandarin AISHELL, which is illustrated in the following Table 12.

TABLE 12
Comparison on test accuracy (%) of different approaches

| Data | Model | 10 dB | 5 dB | 0 dB |
|---|---|---|---|---|
| AURORA2 | G.729B | 72.02 | 69.64 | 65.54 |
| (English) | SVM | 85.21 | 80.94 | 74.26 |
| | MK-SVM | 85.38 | 82.30 | 75.59 |
| | DBN | 86.63 | 81.85 | 76.66 |
| | DDNN | 86.98 | 82.30 | 76.85 |
| | MFCC + Combined | 87.68 | 86.02 | 78.35 |
| AISHELL | MFCC + Combined (16 kHz) | 93.24 | 91.90 | 87.90 |
| (Chinese) | MFCC + Combined (8 kHz) | 93.64 | 92.53 | 92.52 |
| | MFCC + Combined | 96.14 | 94.19 | 93.67 |
| | (16 kHz(from 8 kHz)) | | | |

Wherein, as illustrated in row 7 to 9 of the table, with previous approaches and more recent neural network methods on an English data set AURORA 2, as illustrated in row 1 to 5 of this table, wherein a comparison on accuracy for SNR 10, 5, and 0 dB are recorded. Moreover, language difference could play an important role and render very different results when it comes to building models with acoustic features. The languages of AISHELL and AURORA 2 data differ, as a result the system can also run experiments on AURORA 2 and report, for example some results are illustrated in row 6 of this table.

In terms of the details of experiments for row 6, the system can be configured follow the same choice of utterances and a similar train test split scheme wherein utterances at clean and three different SNR levels, added with ambient noise, can be utilized for training, development, and test at 10 dB, 5 dB, and 0 dB, with the proposed DAE and VAD methods. In other words each of the databases or linguistic models as described above can be recorded at a particular noise level with an associated base truth regarding which portions of the raw waveform represent noise and which represent speech, and a base truth with regard to what the characters or spoken sounds are represented by the speech portions of each waveform.

The utterances can then be derived from the AURORA 2 database, CD 3, and another test set. For the corresponding frame-based VAD ground truths, the generated reference VAD labels as discussed above can be used.

From the fair comparison point of view, it will be appreciated that a sampling rate of AURORA 2 in an exemplary embodiment is 8 kHz, which differs from AISHELL (16 kHz).

In some embodiments the system can be configured to down-sample AISHELL to 8 kHz to apply the same filtering as AURORA 2 and provide result comparisons, and then up-sample to 16 kHz to perform additional experiments, thus allowing the whole framework to be built in 16 kHz or some other common frequency.

Results of which are presented in row 7 and 8 of the table above, with original results shown in row 6. Notwithstanding the difference in sampling rates, AISHELL and AURORA 2 are essentially similar in speech qualities, variety of speakers, and more importantly noise types, where the MWC noise is similar to the ambient noise added to AURORA 2 data, i.e. airport noise.

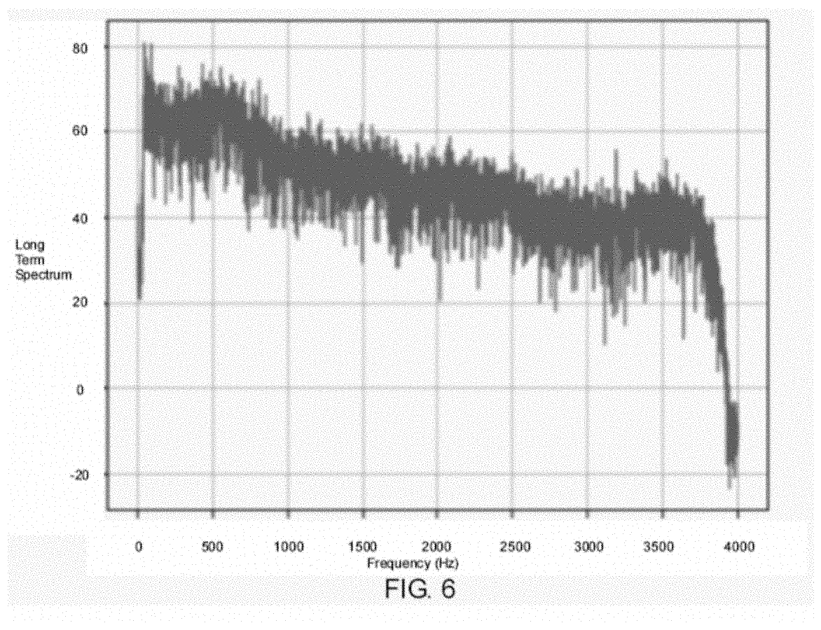

To illustrate this point, FIG. 6 illustrates an exemplary graph showing a plot of a long-term spectrum of the MWC noise at an 8 kHz sampling rate which can be compared with the long-term spectrum of the airport noise used for experiments and is very similar to an Aurora 2 model.

It can be noted that as illustrated herein the G.729B model and its VAD accuracy delineates a baseline. Overall, neural network methods like DNN outperform SVM based methods. At all three SNRs, the best model is the proposed CNN/MFCC+combined features model on both AURORA 2 and AISHELL data, and the accuracy increases by 2% to 4% especially at lower SNRs like 5 dB or 0 dB. An analysis for the contemplated system's model to outperform the DDNN where both models used denoising techniques is that, first of all, DDNN may suffer a slight performance degradation from the greedy layer-wise pretraining of a very deep stacked DAE, even though the denoising module is fine-tuning on the classification task

Secondly, the convolution and pooling of a CNN leads to a considerable merit over a DNN of handling combined features in the higher layers, especially when some amount of noise still exists in the input speech features, and this is better than fully-connected DNN which handles features in the lower layers. The selection of speech features also contributes to a performance difference. MFCC, Δ and ΔΔ features are helpful in extracting the dynamics of how MFCCs change over time, which were not used by the DDNN. Another important finding lies in the language difference of data.

As the results suggest, VAD of AISHELL could be an easier task compared to that of AURORA 2, where AISHELL results exhibit a roughly 10% higher accuracy score compared to AURORA 2 results. Therefore, the high VAD accuracy on AISHELL from row 7 to 9 is a combined effort of both the proposed model and the data. In some embodiments, the system can train the classifier based on multilingual data sets.

Moreover, an interesting side finding from row 7 to 9 is that, as the signals are down-sampled and then up-sampled, the accuracy goes up instead of going down as expected due to a loss of higher band information. This could be explained by the fact that the low-pass filters provide a smoothing effect, which consequently reduced frame-by-frame errors.

It should also be appreciated that the system and methods contemplated herein allow for lowering CPU usage of a VAD app by means of neural network compression.

For optimized on-device app deployment, the system can select two neural network compression frameworks to compress and deploy the system models, including TensorFlow Mobile (TFM) and Qualcomm Snapdragon Neural Processing Engine (SNPE) SDK. The main idea of the app using either TFM or SNPE modules is to produce an estimate of when speech is present, smooths those estimates with averaging, then thresholds that average to come up with a crude speech/non-speech estimate.

Specifically, the module consists of a recorder and a detector, where the recorder uses a bytebuffer to store 10×160 frames, for example 16 kHz samples/sec and 10 ms frame rate of 100 ms of waveform, calculate MFCCs and form 21-frame windows, and send that to the detector. The delay of the detector is thus approximately 210 ms. The softmax score (from 0 to 1) every 10 ms is smoothed by a moving average. The resulting average is then compared against a confidence threshold to come up with a binary estimate of speech/nonspeech.

The following Table 13 depicts exemplary SPU usages when implementing the contemplated methods by the contemplated system, wherein the accuracy is illustrated in parenthesis.

TABLE 13
CPU Usage

| Snapdragon | 820 | 835 |
|---|---|---|
| TFM | 40% (89.04%) | 34% (87.25%) |
| SNPE | 23% (88.30%) | 15% (89.98%) |

For testing under different noise conditions, the averages of CPU usage of all levels are recorded. Using these frameworks, the system's model achieves an average of 28% CPU usage on an exemplary phone, where using TFM, or TF Lite, a default way for model optimization in TensorFlow, would result in an average of 37% CPU usage across the two Snapdragon chip versions, and using SNPE would obtain an average of 19% CPU usage. Furthermore, it was observed that SNPE is a more designated platform for reducing CPU usage on these Snapdragon based devices, and using SNPE could achieve an average reduction of 18% (37%-19%) of CPU usage compared to using TFM. Meanwhile, averaging the 4 CPU usages shown in the table, the system obtained the average on-device inference accuracy of 88.6%.

It will be appreciated that they system can also be optimized to achieve even lower CPU usage on more advanced devices as they are developed. What is more, this model could also run on GPU and DSP, and the compressed model can be further quantized within the two frameworks.

As contemplated herein, and as shown in FIG. 3, the system has drawn comparisons on a CNN based VAD model using different feature sets in noisy conditions on multiple languages. As such, it has been observed that using a CNN adding DAE with MFCC, Δ and ΔΔ features is most helpful for improving VAD performance in high noise. With the considerable number of parameters used in the network, deploying the model on device may result in high CPU usage. To tackle the problem of high CPU usage, the system can be configured to optimize the inference model with neural network compression frameworks.

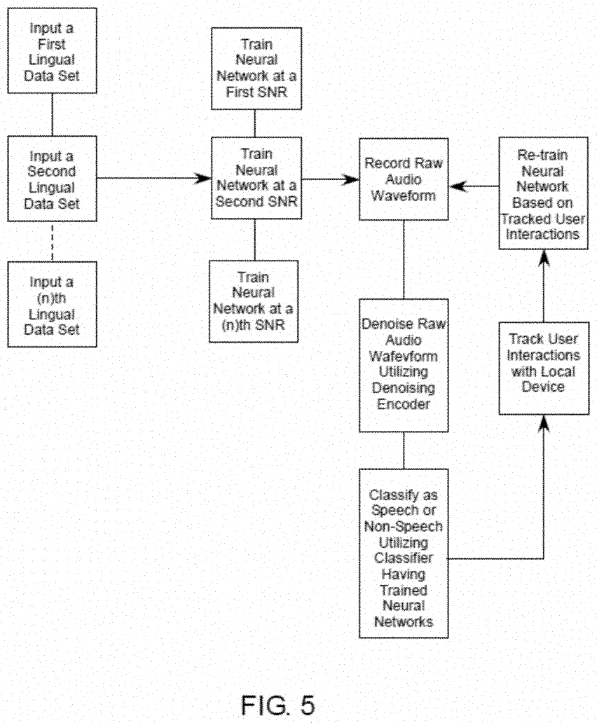

In some embodiments, such as in the system shown in FIG. 5 the system can also include a user interface which can be utilized to track user interactions with the system, wherein various electronic functions, such as manual initiation of voice input, any corrections made to the extracted speech represented as text, or exiting or termination of command functions activated can then be tracked and utilized to update training databases or linguistic models and thus improve the accuracy of the neural networks in determining speech.

In some instances, such as when voice input is manually initiated, the system can earmark raw audio waveforms received for a predetermined time prior to manual initiation which can be used in future linguistic training models with associated base truths.

The foregoing has provided a detailed description on a method and system for recognizing speech according to some embodiments of the present disclosure. Specific examples are used herein to describe the principles and implementations of some embodiments.

In the above embodiments, the existing functional elements or modules can be used for the implementation. For example, the existing sound reception elements can be used as microphones; at least, headphones used in the existing communication devices have elements that perform the function; regarding the sounding position determining module, its calculation of the position of the sounding point can be realized by persons skilled in the art by using the existing technical means through corresponding design and development; meanwhile, the position adjusting module is an element that any apparatuses with the function of adjusting the state of the apparatus have.

The VAD system according to some embodiments of the disclosure can employ other approaches, including passive approaches and/or active approaches to improve robustness of voice activity detection in an noisy environment.

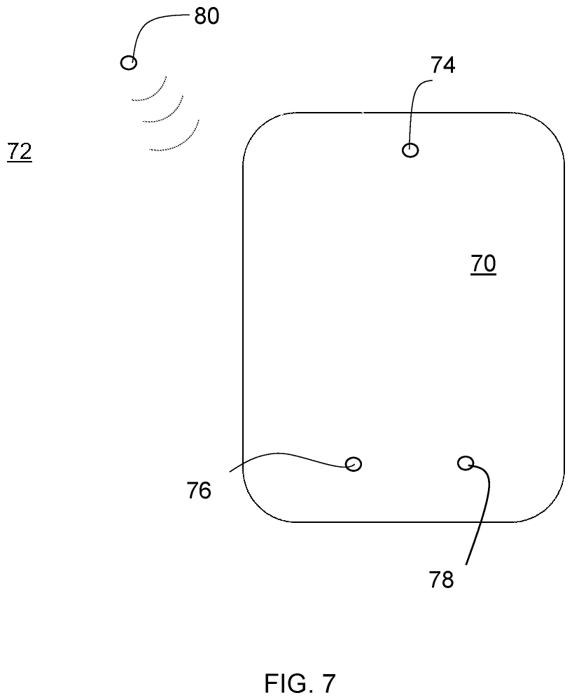

In an example, FIG. 7 illustrates an apparatus 70 in an environment 72, such as a noisy environment. The apparatus can be equipped with one or more microphones 74, 76, 78 for receiving sound waves.

In some embodiments, the plurality of strategically positioned microphones 74, 76, 78 can facilitate establishing a three-dimensional sound model of the sound wave from the environment 72 or a sound source 80. As such, voice activity detection can be improved based on the three-dimensional sound model of the sound wave received by the plurality of microphones and processed by the VAD system.

The microphones are not necessarily flush with the surface of the apparatus 70, as in most smart phones. In some embodiments, the microphones can protrude from the apparatus, and/or can have adjustable positions. The microphone can also be of any sizes.

In some embodiments, the microphones are equipped with windscreens or mufflers, to suppress some of the noises passively.

In some embodiments, active noise cancelling or reduction can be employed, to further reduce the noises, thereby improving voice activity detections.

To provide for interaction with a user, implementations of the subject matter described in this specification can be implemented with a computer and/or a display device, such as a display screen for the apparatus 70. The display screen can be, e.g., a CRT (cathode-ray tube), an LCD (liquid-crystal display), an OLED (organic light-emitting diode) driven by TFT (thin-film transistor), a plasma display, a flexible display, or any other monitor for displaying information to the user such a VR/AR device, a head-mount display (HMD) device, a head-up display (HUD) device, smart eyewear (e.g., glasses), etc. Other devices, such as a keyboard, a pointing device, e.g., a mouse, trackball, etc., or a touch screen, touch pad, etc., can also be provided as part of system, by which the user can provide input to the computer.

The devices in this disclosure can include special purpose logic circuitry, e.g., an FPGA (field-programmable gate array), or an ASIC (application-specific integrated circuit). The device can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The devices and execution environment can realize various different computing model infrastructures, such as web services, distributed computing, and grid computing infrastructures.

Examples of situations in which VAD systems might be used in high-noise situations can include utilizing a smart device in an airport, in a vehicle, or in an industrial environment. However, where many users may just suspend use of VAD devices until exiting such environmental conditions, some users may be dependent on such devices and may require the VAD to perform even in these environments.

Examples may include users with degenerative neural diseases, etc. which users may not have an option of exiting an environment or communicating using alternative means. Improvement in VAD systems will allow for more versatile uses and increased ability for users to depend on said systems.

Additionally, increased reliability of VAD systems in noisy conditions may also allow for additional communication and voice command sensitive systems in previously non-compatible systems, for example vehicular systems, commercial environments, factory equipment, motor craft, aircraft control systems, cockpits, etc.

However, VAD system improvements will also improve performance and accuracy of such systems even in quiet conditions, such as for smart homes, smart appliances, office atmospheres, etc.

In some embodiments, the VAD system can be part of a voice-command based smart home, a voice-operated remote controller configured to activate and operate remove appliances such as lights, dishwashers, washers and driers, TVs, window blinds, etc.

In some other embodiments, the VAD system can be part of a vehicle, such as an automobile, an aircraft, a boat, etc. In the automobile for example, the noises can come from the road noise, engine noise, fan noise, tire noise, passenger chatters, etc., and the VAD system disclosed herein can facilitate recognizing voice commands by the user(s)'s, such as realizing driving functions or entertainment functions.

In another example, in an aircraft cockpit, the VAD system disclosed herein can facilitate recognizing the pilot(s)'s voice commands accurately to perform aircraft control such as autopilot functions and running checklists, in the cockpit environment with noise from the engine and the wind.

In another example, a wheelchair user can utilize the VAD system to realize wheelchair control in a noisy street environment.

For the convenience of description, all the components of the device are divided into various modules or units according to functions, and are separately described. Certainly, when various embodiments of the present disclosure is carried out, the functions of these modules or units can be achieved in one or more hardware or software

Those of ordinary skill in the art should understand that the embodiments of the present disclosure can be provided for a method, system, or computer program product.

As such, various embodiments of the present disclosure can be in a form of all-hardware embodiments, all-software embodiments, or hardware-software embodiments.

Moreover, various embodiments of the present disclosure can be in a form of a computer program product implemented on one or more computer-applicable memory media (including, but not limited to, disk memory, CD-ROM, optical disk, etc.) containing computer-applicable procedure codes therein.

Various embodiments of the present disclosure are described with reference to the flow diagrams and/or block diagrams of the method, apparatus (system), and computer program product of the embodiments of the present disclosure.

It should be understood that computer program instructions realize each flow and/or block in the flow diagrams and/or block diagrams as well as a combination of the flows and/or blocks in the flow diagrams and/or block diagrams.

These computer program instructions can be provided to a processor of a general-purpose computer, a special-purpose computer, an embedded memory, or other programmable data processing apparatuses to generate a machine, such that the instructions executed by the processor of the computer or other programmable data processing apparatuses generate a device for performing functions specified in one or more flows of the flow diagrams and/or one or more blocks of the block diagrams.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA, or an ASIC.

Processors suitable for the execution of a computer program include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

These computer program instructions can also be stored in a computer-readable memory that can guide the computer or other programmable data processing apparatuses to operate in a specified manner, such that the instructions stored in the computer-readable memory generate an article of manufacture including an instruction device. The instruction device performs functions specified in one or more flows of the flow diagrams and/or one or more blocks of the block diagrams.

These computer program instructions may also be loaded on the computer or other programmable data processing apparatuses to execute a series of operations and steps on the computer or other programmable data processing apparatuses, such that the instructions executed on the computer or other programmable data processing apparatuses provide steps for performing functions specified ill one or more flows of the flow diagrams and/or one or more blocks of the block diagrams.

Although preferred embodiments of the present disclosure have been described, persons skilled in the art can alter and modify these embodiments once they know the fundamental inventive concept. Therefore, the attached claims should be construed to include the preferred embodiments and all the alternations and modifications that fall into the extent of the present disclosure.

While this specification contains many specific implementation details, these should not be construed as limitations on the scope of any claims, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination.

Moreover, although features may be described above as acting in certain combinations and even initially claimed as such, one or more features from a claimed combination can in some cases be excised from the combination, and the claimed combination may be directed to a subcombination or variation of a subcombination.

The description is only used to help understanding some of the possible methods and concepts. Meanwhile, those of ordinary skill in the art can change the specific implementation manners and the application scope according to the concepts of the present disclosure. The contents of this specification therefore should not be construed as limiting the disclosure.

In the foregoing method embodiments, for the sake of simplified descriptions, they are expressed as a series of action combinations. However, those of ordinary skill in the art will understand that the present disclosure is not limited by the particular sequence of steps as described herein.

According to some other embodiments of the present disclosure, some steps can be performed in other orders, or simultaneously, omitted, or added to other sequences, as appropriate.

In addition, those of ordinary skill in the art will also understand that the embodiments described in the specification are just some of the embodiments, and the involved actions and portions are not all exclusively required, but will be recognized by those having skill in the art whether the functions of the various embodiments are required for a specific application thereof.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

Various embodiments in this specification have been described in a progressive manner, where descriptions of some embodiments focus on the differences from other embodiments, and same or similar parts among the different embodiments are sometimes described together in only one embodiment.

It should also be noted that in the present disclosure, relational terms such as first and second, etc., are only used to distinguish one entity or operation from another entity or operation, and do not necessarily require or imply these entities having such an order or sequence. It does not necessarily require or imply that any such actual relationship or order exists between these entities or operations.

Moreover, the terms “include,” “including,” or any other variations thereof are intended to cover a non-exclusive inclusion such that a process, method, article, or apparatus that comprises a list of elements including not only those elements but also those that are not explicitly listed, or other elements that are inherent to such processes, methods, goods, or equipment.

In the case of no more limitation, the element defined by the sentence “includes a . . . ” does not exclude the existence of another identical element in the process, the method, the commodity, or the device including the element.

In the descriptions, with respect to device(s), terminal(s), etc., in some occurrences singular forms are used, and in some other occurrences plural forms are used in the descriptions of various embodiments. It should be noted, however, that the single or plural forms are not limiting but rather are for illustrative purposes. Unless it is expressly stated that a single device, or terminal, etc. is employed, or it is expressly stated that a plurality of devices, or terminals, etc. are employed, the device(s), terminal(s), etc. can be singular, or plural.

Based on various embodiments of the present disclosure, the disclosed apparatuses, devices, and methods can be implemented in other manners. For example, the abovementioned terminals devices are only of illustrative purposes, and other types of terminals and devices can employ the methods disclosed herein.

Dividing the terminal or device into different “portions,” “regions” “or “components” merely reflect various logical functions according to some embodiments, and actual implementations can have other divisions of “portions,” “regions,” or “components” realizing similar functions as described above, or without divisions. For example, multiple portions, regions, or components can be combined or can be integrated into another system. In addition, some features can be omitted, and some steps in the methods can be skipped.

Those of ordinary skill in the art will appreciate that the portions, or components, etc. in the devices provided by various embodiments described above can be configured in the one or more devices described above. They can also be located in one or multiple devices that is (are) different from the example embodiments described above or illustrated in the accompanying drawings. For example, the circuits, portions, or components, etc. in various embodiments described above can be integrated into one module or divided into several sub-modules.

The numbering of the various embodiments described above are only for the purpose of illustration, and do not represent preference of embodiments.

Although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the disclosure defined in the following claims, the scope of which is to be accorded the broadest interpretation to encompass such modifications and equivalent structures.

1. A voice activity detection method comprising:
training one or more computerized neural networks having a denoising autoencoder and a classifier, wherein the training is performed utilizing one or more models including Mel-frequency cepstral coefficients (MFCC) features, Δ features, ΔΔ features, and Pitch features, each model being recorded at one or more differing associated predetermined signal to noise ratios;
recording a raw audio waveform and transmitting the raw audio waveform to the computerized neural network;
denoising the raw audio wave utilizing the denoising autoencoder; and
determining whether the raw audio waveform contains human speech;
extracting any human speech from the raw audio waveform.

2. The voice activity detection method of claim 1,
wherein the computerized neural network is a convolutional neural network.

3. The voice activity detection method of claim 1,
wherein the computerized neural network is a deep neural network.

4. The voice activity detection method of claim 1,
wherein the computerized neural network is a recurrent neural network.

5. The voice activity detection method of claim 1,
wherein the classifier is trained utilizing one or more linguistic models.

6. The voice activity detection method of claim 5,
wherein the classifier is trained utilizing a plurality of linguistic models.

7. The voice activity detection method of claim 6,
wherein at least one linguistic model is VoxForge™.

8. The voice activity detection method of claim 6,
wherein at least one linguistic model is AIShell.

9. The voice activity detection method of claim 6,
wherein at least one linguistic model is VoxForge™; and
wherein at least one additional linguistic model is AISHELL.

10. The voice activity detection method of claim 6,
wherein each linguistic model is recorded having a base truth, wherein each linguistic model is recorded at one or more of a plurality of pre-set signal to noise ratios.

11. The voice activity detection method of claim 10,
wherein each linguistic model is recorded having a base truth, wherein each linguistic model is recorded at a plurality of pre-set signal to noise ratios.

12. The voice activity detection method of claim 11,
wherein the plurality of pre-set signal to noise ratios range between 0 dB and 35 dB.

13. The voice activity detection method of claim 6,
wherein the raw audio waveform is recorded on a local computational device, and wherein method further comprises a step of transmitting the raw audio waveform to a remote server, wherein the remote server contains the computational neural network.

14. The voice activity detection method of claim 6,
wherein the raw audio waveform is recorded on a local computational device, and wherein the local computational device contains the computational neural network.

15. The voice activity detection method of claim 14,
wherein the computational neural network is compressed.

16. A voice activity detection system, the system comprising:
a local computational system, the local computational system comprising:
processing circuitry;
a microphone operatively connected to the processing circuitry;
a non-transitory computer-readable media being operatively connected to the processing circuitry;
a remote server configured to receive recorded wavelengths from the local computational system; the remote server having one or more computerized neural networks, a denoising autoencoder module, and a classifier module, wherein the computerized neural networks of the remote server are trained on a plurality of acoustic models, wherein each of the plurality of acoustic models represent a particular linguistic dataset recorded in one or more associated noise predetermined signal to noise ratios;
wherein the non-transitory computer-readable media contains instructions for the processing circuitry to perform the following tasks:
utilize the microphone to record raw audio waveforms from an ambient atmosphere;
transmit the recorded raw audio waveforms to the remote server; and
wherein the remote server contains processing circuitry configured to utilize the denoising autoencoder module to perform a denoising operation on the recorded waveform and utilize the classifier to classify the recorded wavelengths as speech or non-speech, extract the speech from the recorded raw audio waveforms, perform a speech-to-text operation, and transmit one or more extracted strings of speech characters back to the local computational system.

17. The voice activity detection system of claim 16,
wherein the classifier is trained utilizing a plurality of linguistic models, wherein at least one linguistic model is VoxForge™ and at least one linguistic model is AIShell.

18. A vehicle comprising a voice activity detection system, the system comprising:
a local computational system, the local computational system further comprising:
processing circuitry;
a microphone operatively connected to the processing circuitry;
a non-transitory computer-readable media being operatively connected to the processing circuitry;
one or more computerized neural networks including:
a denoising autoencoder module, and
a classifier module, wherein the computerized neural networks are trained on a plurality of acoustic models, wherein each of the plurality of acoustic models represent a particular linguistic dataset recorded in one or more associated noise predetermined signal to noise ratios;
wherein the non-transitory computer-readable media contains instructions for the processing circuitry to perform the following tasks:
utilize the microphone to record raw audio waveforms from an ambient atmosphere;
transmit the recorded raw audio waveforms to the one or more computerized neural networks; and
wherein at least one computerized neural network is configured to utilize the denoising autoencoder module to perform a denoising operation on the recorded waveform and utilize the classifier to classify the recorded wavelengths as speech or non-speech, extract the speech from the recorded raw audio waveforms, perform a speech-to-text operation, and transmit one or more extracted strings of speech characters back to the local computational system.

19. The vehicle of claim 18,
wherein the classifier is trained utilizing a plurality of linguistic models, wherein at least one linguistic model is VoxForge™ and at least one linguistic model is AIShell; and
wherein the computational neural network is compressed.

20. The vehicle of claim 18,
wherein the vehicle is one of an automobile, a boat, or an aircraft.
